(19) United States
(12) Patent Application Publication
(10) Pub. No.: US 2024/0390950 A1
(43) Pub. Date: Nov. 28, 2024

(54) METHOD AND APPARATUS FOR SUBSTRATE CLEANING IN STACK-DIE HYBRID BONDING PROCESS

(71) Applicant: Applied Materials, Inc., Santa Clara, CA (US)

(72) Inventors: Ke ZHENG, Singapore (SG); Guan Huei SEE, Singapore (SG); Ying W. WANG, Singapore (SG); Ruiping WANG, San Jose, CA (US); Prayudi LIANTO, Singapore (SG)

(21) Appl. No.: 18/200,539

(22) Filed: May 22, 2023

(51) Int. Cl. B08B 1/00; B08B 1/02; B08B 3/02

(52) U.S. Cl. CPC B08B 1/12; B08B 1/20; B08B 3/022

(57) ABSTRACT

A brush box cleaning module is introduced as part of the pre-treatment process flow in an integrated hybrid bonding platform. It addresses the technical problem of achieving high cleanliness levels on die front-side and back-side surfaces, particularly by removing residues and particles induced by backgrinding tape and dicing tape. The brush box cleaning module efficiently removes stubborn residues and particles both chemically and mechanically, resulting in a clean and passivated surface without causing watermarks, scratches, corrosion, or surface roughness. This disclosed approach enhances the bonding yield and provides significant advantages over existing methods in die-stack hybrid bonding applications.

### BACKGROUND

### Field

Embodiments of the present disclosure relates generally to semiconductor manufacturing, and more specifically, to a hybrid bonding platform incorporating a brush box module for cleaning substrates in die-stack bonding applications.

### Description of the Related Art

Semiconductor devices are widely used in various electronic products and systems, ranging from consumer electronics to industrial and military applications. As the demand for increasingly complex and miniaturized electronic devices continues to grow, the semiconductor manufacturing industry has sought to develop advanced packaging technologies that enable the integration of multiple dies or layers within a single device. Die-stack bonding, a method of vertically stacking dies on top of each other, is one such advanced packaging technique that offers benefits such as increased functionality, reduced form factor, and improved performance.

In die-stack bonding applications, the cleanliness of the die surfaces is critical to achieving high bonding yield and reliability. Contaminants such as residues and particles introduced during wafer processing, backgrinding, dicing, or other fabrication steps can negatively impact the bonding process, leading to defects or failures in the resulting semiconductor devices. To address this issue, various cleaning methods have been developed for removing contaminants from die surfaces prior to bonding.

One such cleaning method is wet cleaning, which typically involves the use of liquid chemicals, such as solvents, acids, or bases, to remove contaminants from the die surface. Wet cleaning processes may employ megasonic or atomizer cleaning techniques to enhance the removal of contaminants. However, these wet cleaning methods have limitations, particularly in their ability to remove stubborn residues and particles induced by backgrinding tape or dicing tape from the die surfaces. Furthermore, wet cleaning processes can sometimes cause undesirable side effects, such as watermarks, scratches, corrosion, or surface roughness, which can negatively impact the bonding process and device performance.

In the related art, various alternative cleaning methods have been proposed to address the limitations of wet cleaning. These methods include dry cleaning, plasma cleaning, and laser cleaning, among others. While these alternative cleaning methods offer certain advantages, they may not be effective in all situations or compatible with all substrate materials, and they may also have their own limitations and drawbacks.

In view of the foregoing, there remains a need for an improved cleaning method and system for die-stack bonding applications that effectively removes residues and particles from die surfaces without causing undesirable side effects, and that is adaptable for use in various bonding embodiments, such as die-to-wafer and wafer-to-wafer bonding. It addresses this need by providing an integrated hybrid bonding platform incorporating a brush box cleaning module for enhanced substrate surface cleaning.

### SUMMARY

Embodiments described herein provide a hybrid bonding platform, a brush box assembly for cleaning a substrate, and a process of manufacturing a stacked semiconductor structure that addresses the above-identified needs.

In a first aspect, embodiments of the disclosure provide a hybrid bonding platform comprising a substrate handling system configured to transport a substrate through the platform; a brush box cleaning module configured to clean a surface of the substrate by removing residues and particles; a bonding module configured to bond dies of the substrate; and a controller configured to control the substrate handling system, the brush box cleaning module, and the bonding module.

In a second aspect, embodiments of the disclosure provide a brush box assembly for cleaning a substrate in a hybrid bonding platform, the brush box assembly comprising a housing configured to enclose the substrate; a plurality of brushes configured to engage with a surface of the substrate; and a cleaning agent delivery system configured to deliver a cleaning agent to the plurality of brushes.

In a third aspect, embodiments of the disclosure provide a process of manufacturing a stacked semiconductor structure, the process comprising providing a substrate comprising a plurality of dies; cleaning a surface of the substrate using a brush box cleaning module to remove residues and particles; and bonding the dies of the substrate using a hybrid bonding process.

These and other aspects, features, and advantages of the present disclosure will become more apparent from the following detailed description when taken in conjunction with the accompanying drawings.

### BRIEF DESCRIPTION OF THE DRAWINGS

So that the manner in which the recited features of the present disclosure may be understood in detail, a more particular description of the disclosure may be had by reference to one or more embodiments, some of which are illustrated in the appended drawings. It is to be noted, however, that the appended drawings illustrate only one or more of the several embodiments; therefore, the one or more embodiments provided in the Drawings are not to be considered limiting of the broadest interpretation of the detailed scope. Other effective embodiments as may be described in the Detailed Description may be considered part of the envisioned detailed scope.

FIG. 1 is a schematic illustration of an exemplary hybrid bonding platform, according to one or more embodiments.

FIG. 2A is an isometric view of an example of a brush cleaner utilized in the hybrid bonding platform of FIG. 1, according to one or more embodiments.

FIG. 2B is a top view of the brush cleaner of FIG. 2A, according to one or more embodiments.

FIG. 2C is an isometric view of a scrubbing device disposed within the brush cleaner in a loaded state (a substrate is loaded therein), according to one or more embodiments.

FIG. 2D is an isometric view of a scrubbing device disposed within the brush cleaner in an idle state (a substrate is not loaded), according to one or more embodiments.

FIG. 3 is a flowchart illustrating an exemplary process of manufacturing a stacked semiconductor structure, according to one or more embodiments.

To facilitate understanding and better appreciation for the described scope, in some instances either identical or associated reference numerals have been used where possible to designate identical or similar elements that are common in the figures. One of skill in the art may appreciate that elements and features of one embodiment may be beneficially incorporated in one or more other embodiments without further recitation.

### DETAILED DESCRIPTION

Embodiments described herein provide an improved method and system for cleaning substrates in die-stack bonding applications by incorporating a brush box module into an integrated hybrid bonding platform for advanced packaging. The brush box module effectively removes residues and particles from die surfaces without causing watermarks, scratches, corrosion, or surface roughness, leading to enhanced bonding yield.

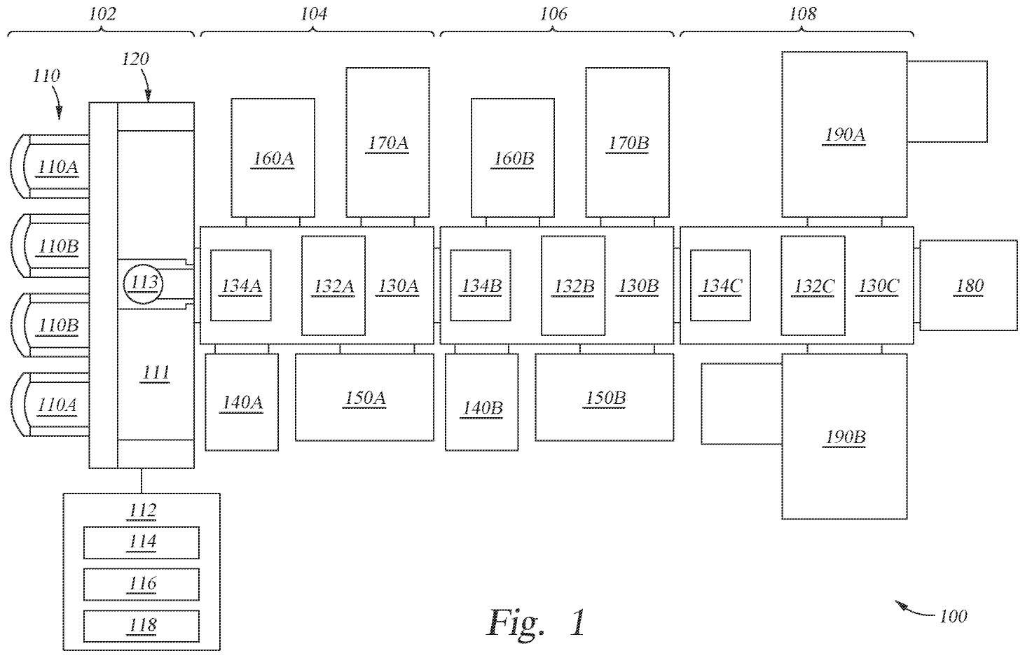

FIG. 1 shows a schematic illustration of an exemplary integrated hybrid bonding platform 100 for advanced packaging according to an embodiment of the present disclosure. The hybrid bonding platform 100 is designed to facilitate the precise and efficient bonding of semiconductor devices through an automated process. In one embodiment, hybrid bonding platform 100 comprises an Equipment Front End Module (EFEM) 102, responsible for loading and unloading substrates from multiple substrate cassettes 110, surface preparation modules 104 and 106, which are designed to clean and activate substrates in preparation for bonding, a bonding module 108, responsible for executing the hybrid bonding process, which involves bonding source substrates 110A to target substrates 110B, and a system controller 112, which manages and coordinates the operation of the various modules within the hybrid bonding platform 100.

The Equipment Front End Module (EFEM) 102, as disclosed in the integrated hybrid bonding platform 100, comprises a support structure configured to accommodate a plurality of substrate cassettes 110, said substrate cassettes 110 being adapted to retain source substrates 110A and target substrates 110B. The EFEM 102 further includes a housing 111 enclosing a chamber, wherein said chamber provides a controlled environment for the handling and processing of the substrates. The enclosed chamber is configured to maintain cleanliness and integrity of the substrates during the bonding process by mitigating the risk of contamination and exposure to external factors. In addition, the Equipment Front End Module 102 is equipped with one or more factory interface robots 113, said robots being operatively connected to the chamber and configured to transfer substrates between the substrate cassettes and various modules of the hybrid bonding platform 100. The factory interface robots 113 ensure precise and efficient movement of substrates through the system by automating substrate transfers, thereby contributing to the overall efficacy of the hybrid bonding process.

The surface preparation module 104 is specifically designed to perform a series of cleaning and activation steps on substrates, such as semiconductor wafers, using an integrated and automated system. In one embodiment, a surface preparation module 104 comprises an Automated Modular Mainframe (AMM) 130A, a brush box clean module 140A, a wet clean module 150A, a degas module 160A, and a plasma module 170A.

The Automated Modular Mainframe (AMM) 130A serves as the central hub of the system, coordinating the transfer of substrates between different sub-modules. This mainframe utilizes a substrate transfer robot that moves the substrates between various process stations, ensuring precise handling and minimizing the risk of contamination or damage. The Automated Modular Mainframe 130A comprises a wafer aligner 132A and an in-line metrology system 134A. These components work in tandem to ensure proper substrate alignment and verification of surface characteristics before and after the surface preparation process. The wafer aligner 132A is configured to accurately align the substrates, ensuring that they are positioned precisely according to the requirements of the bonding process. The in-line metrology system 134A is adapted to measure and verify the substrate surface characteristics, including cleanliness, activation level, and other relevant parameters, both before and after the cleaning and activation steps performed by the surface preparation module 104.

The brush box clean module 140A provides mechanical cleaning of the substrate surfaces, removing particles and contaminants using brushes or other mechanical scrubbing means. This module can be customized to use different brush materials, rotational speeds, and cleaning chemistries to achieve the desired level of cleanliness.

The wet clean module 150A is responsible for chemical cleaning of the substrates, using various liquid cleaning agents to remove contaminants that may not be effectively removed by mechanical means. These cleaning agents can include deionized water, acids, bases, or other specialized chemistries, depending on the specific requirements of the process and substrate materials.

The degas module 160A is configured for outgassing the substrates by removing residual liquids, gases and contaminants that may have been adsorbed or trapped on the substrate surfaces during prior processing steps. This step is crucial for ensuring that the substrate surface is free of contaminants that might interfere with subsequent processing steps.

The plasma module 170A is designed and configured for effective and efficient radical/plasma RPS/RF cleaning or activation processes. The plasma module 170A includes a Remote Plasma Source (RPS) that can be selectively positioned on the top, side wall, or any combination thereof of the chamber, providing flexibility in RPS placement. The RPS is further equipped with engineered hardware components, such as baffles and/or diffuser plates, which facilitate uniform distribution of gases or radicals within the chamber, thereby ensuring consistent process control and reproducibility.

In one or more embodiments, the plasma module 170A is configured to operate in a variety of RPS/RF processes, including, but not limited to, RPS, RF plasma, RF-assisted RPS, RPS-assisted RF plasma, or intermittent RPS/RF processing. This versatility enables tailored cleaning or activation processes to be implemented, depending on the specific substrate materials and bonding applications being employed.

The plasma module 170A is further adapted to utilize a range of RPS/RF clean or activation gas chemistries, comprising, but not limited to, H₂, N₂, Ar, He, NH₃, NF₃, and CDA. Such compatibility with various gas chemistries allows the plasma module 170A to accommodate a multitude of substrate materials and surface conditions, thereby optimizing surface preparation for the hybrid bonding process.

The surface preparation module 106 may include similar sub-modules or alternative sub-modules as needed to address specific substrate cleaning and activation requirements. Collectively, the surface preparation modules 104 and 106 ensure that the source substrates 110A and target substrates 110B are thoroughly cleaned and activated, preparing them for the subsequent bonding process within the integrated hybrid bonding platform 100.

The bonding module 108 is responsible for executing the bonding of dies from the source substrate 110A to the target substrate 110B, following surface preparation. This module plays a key role in ensuring the high precision and reliability required for semiconductor device assembly. The bonding module 108 comprises an Automated Modular Mainframe (AMM) 130C, a UV module 180, and one or more bonders 190. The Automated Modular Mainframe 130C serves as the central control unit, managing and coordinating the operations of the UV module 180 and the bonder 190 to ensure efficient and accurate die bonding. The UV module 180 is responsible for weakening the adhesive holding the dies to the source substrate 110A. By exposing the tape frame to ultraviolet light, the adhesive's molecular structure changes, reducing its strength and allowing for the easy release of dies without causing damage. Finally, the bonder 190 performs the pick, flip, placement, and bonding of dies. With the use of a highly accurate robotic system, the bonder 190 ensures precise alignment and positioning of dies throughout the hybrid bonding process. It picks up the dies from the source substrate 110A, flips them to the correct orientation, accurately places them onto the target substrate 110B, and initiates the bonding process, which may involve pressure, heat, or both. The terms substrate and wafer are utilized interchangeably throughout the disclosure provided herein to describe a multiple die containing work piece on which one or more of the methods described herein are to be performed on.

A system controller 112, such as a programmable computer, is coupled to the integrated hybrid bonding platform 100 for controlling one or more of the components therein. In one embodiment, the system controller 112 may control the wafer handling and transferring between different processing modules to perform a process sequence. In another embodiment, the system controller 112 may control the operation of brush box cleaning module 140, which is described further below. In operation, the system controller 112 enables data acquisition and feedback from the respective components to coordinate processing in the integrated hybrid bonding platform 100. The system controller 112 includes a programmable central processing unit (CPU) 114, which is operable with a memory 116 (e.g., non-volatile memory) and support circuits 118. The support circuits 118 (e.g., cache, clock circuits, input/output subsystems, power supplies, etc., and combinations thereof) are conventionally coupled to the CPU 114 and coupled to the various components within the integrated hybrid bonding platform 100.

In operation, the hybrid bonding process flow begins by loading of source substrates 110A and target substrates 110B onto the Equipment Front End Module 102 by one or more factory interface robots 113. The substrates 110A and 110B, which comprise a plurality of dies, are then transported through the integrated hybrid bonding platform 100 by the Automated Modular Mainframe 130A and 130B.

Next, the substrates 110A and 110B are aligned using the wafer aligners 132A and 132B to ensure accurate die placement during the bonding process. The aligned substrates 110A and 110B are then transported to the brush box cleaning modules 140A and 140B, where residues and particles induced by backgrinding tape or dicing tape are removed from the substrate surface. The brush box cleaning modules 140A and 140B may include a housing configured to enclose the substrates 110A and 110B, a plurality of brushes configured to engage with the substrate surface, and a cleaning agent delivery system configured to deliver a cleaning agent to the plurality of brushes.

After the initial brush box cleaning, the substrates 110A and 110B are subjected to a wet cleaning step in the wet clean modules 150A and 150B, which may involve the delivery of cleaning and rinsing fluids along with the use of megasonic or atomizer cleaning methods to remove contaminants from the substrate surface.

Following the wet cleaning, the substrates 110A and 110B are transported to the degas modules 160A and 160B, where unwanted gases, moisture, or contaminants are removed from the surface of a substrate or a die containing work piece. The degas process typically involves heating the substrate or work piece to a specific temperature, causing the contaminants, trapped gases, or moisture to evaporate or desorb from the surface. In some cases, the process may also involve applying a vacuum or an inert gas to facilitate the removal of contaminants. Proper degassing can improve adhesion, reduce defects, and enhance the overall performance of the semiconductor device, particularly in the context of die-stack hybrid bonding applications.

The degassed substrates 110A and 110B are then treated in the plasma modules 170A and 170B for surface activation and further cleaning. During the plasma activation process, the surfaces of the dies or wafers are exposed to the plasma, which contains charged particles such as ions and electrons. These high-energy ions bombard the surface, removing contaminants and activating the surface by creating reactive sites that increase surface energy and wettability. This activation process makes the surface more hydrophilic and chemically reactive, promoting better adhesion and bonding quality in the hybrid bonding process.

Afterwards, the substrates 110A and 110B are transferred into the chamber of Automated Modular Mainframe 130C and then subsequently treated in a UV module 180 coupled to the Automated Modular Mainframe 130C to facilitate the release of dies from the adhesive tape frame prior to bonding. The UV module works by exposing the tape frame, which holds the dies, to ultraviolet light. The high-energy UV photons interact with the adhesive material, causing the adhesive's molecular structure to change. This change results in a reduction of the adhesive strength, allowing the dies to be easily released from the tape frame.

Finally, the dies of the substrates 110A and 110B are bonded using a hybrid bonding process performed by the bonder 190A or bonder 190B. In the bonder 190, the process of bonding source substrates 110A to target substrates 110B begins with the precise alignment of the dies on the source substrates 110A with the corresponding bonding sites on the target substrates 110B. This alignment is achieved using advanced alignment systems, such as high-resolution cameras and pattern recognition algorithms, which accurately align the copper interconnects and the surrounding dielectric material on the dies or substrates.

Once the alignment is achieved, the bonder module 190 picks up the individual dies from the source substrate 110A using a pick-and-place mechanism. This mechanism may comprise a vacuum-based gripping system or other appropriate mechanisms suitable for handling semiconductor dies. The picked dies are then flipped over and brought into close proximity with the target substrates 110B.

Prior to the actual bonding step, the bonder module 190 may apply a pre-bonding force to bring the surfaces of the source and target substrates into intimate contact. This pre-bonding force ensures that the copper interconnects and dielectric material are in close proximity, which is essential for establishing reliable electrical connections and minimizing defects in the bonded structure.

The bonder module 190 then applies a controlled force and temperature to the source and target substrates to initiate the bonding process. The force and temperature applied during the bonding process depend on the specific bonding technique being used, such as thermo-compression bonding or direct bonding. The bonding process may involve the formation of molecular bonds between the dielectric layers and the fusing of copper pads to establish electrical connections.

Throughout the bonding process, the bonder module 190 is equipped with sensors and feedback systems to monitor critical parameters, such as force, temperature, and alignment accuracy. This real-time monitoring enables fine-tuning and control of the bonding process to ensure optimal bonding performance and yield.

After the bonding process is completed, the bonded dies form a stacked semiconductor structure, with the source substrate 110A being bonded to the target substrate 110B. The bonder module 190 then repeats this process for the remaining dies on the source substrates 110A, iteratively creating a vertically integrated stack of dies or substrates.

The bonding process carried out by the bonder module 190 ensures optimal electrical connections and minimal defects, resulting in high-performance, compact, and multi-functional semiconductor devices.

In the die-to-wafer bonding embodiment, individual dies are bonded to a receiving wafer, which may contain pre-patterned bond pads or other structures for facilitating the bonding process. The dies and receiving wafer are first subjected to the cleaning, degassing, plasma treatment, and UV curing steps as described previously. The bonders 190 are configured to pick up the individual dies, align them with the receiving wafer, and bond them using a hybrid bonding process. This process may involve aligning the bond pads on the dies with corresponding bond pads on the receiving wafer, and applying pressure and heat to form a strong bond between the dies and the receiving wafer.

One or more embodiments described herein involve bonding multiple dies from a donor wafer to a host wafer simultaneously. In this approach, an entire array of dies is aligned and bonded to the host wafer in a single step. In other embodiments, individual dies from a donor wafer are bonded to a host wafer one at a time. In this approach, each die is picked, aligned, and bonded to the host wafer independently.

In the wafer-to-wafer bonding embodiment, two wafers with matching patterns are bonded together, forming a stacked wafer structure. The wafers are first subjected to the cleaning, degassing, plasma treatment, and UV curing steps as described previously. The bonders 190 are configured to align the wafers, ensuring accurate alignment of the bond pads or other structures on each wafer. The aligned wafers are then bonded together using a hybrid bonding process, which may involve applying pressure and heat to form a strong bond between the two wafers.

By incorporating the brush box cleaning modules into the integrated hybrid bonding platform, embodiments of the present disclosure provide an effective and efficient method for removing residues and particles from die surfaces in die-stack bonding applications, leading to improved bonding yield and reliability in the production of semiconductor devices. The embodiments of the disclosure are adaptable for use in various bonding embodiments, including die-to-wafer and wafer-to-wafer bonding, offering flexibility in advanced packaging applications.

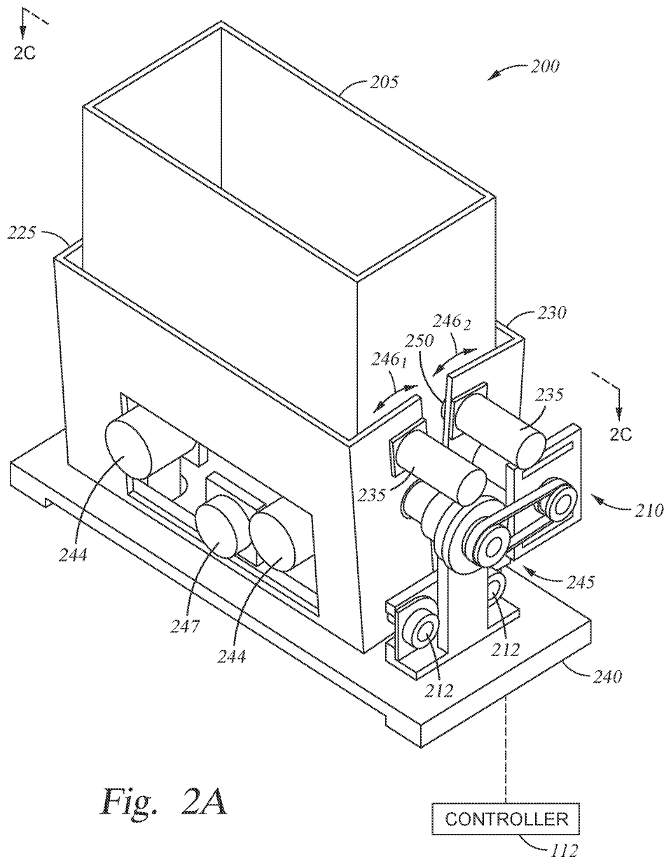

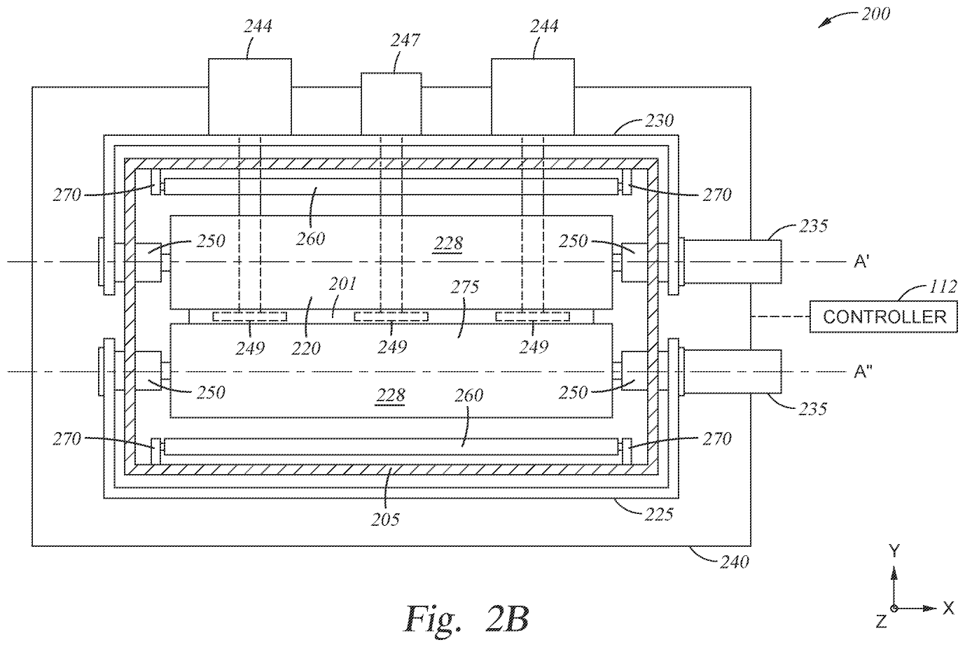

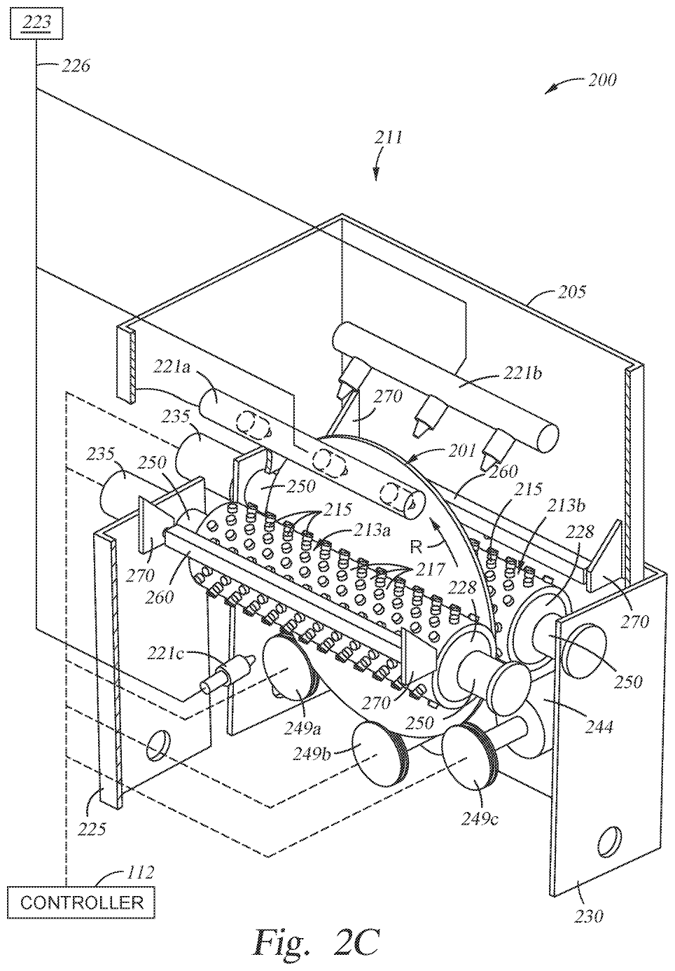

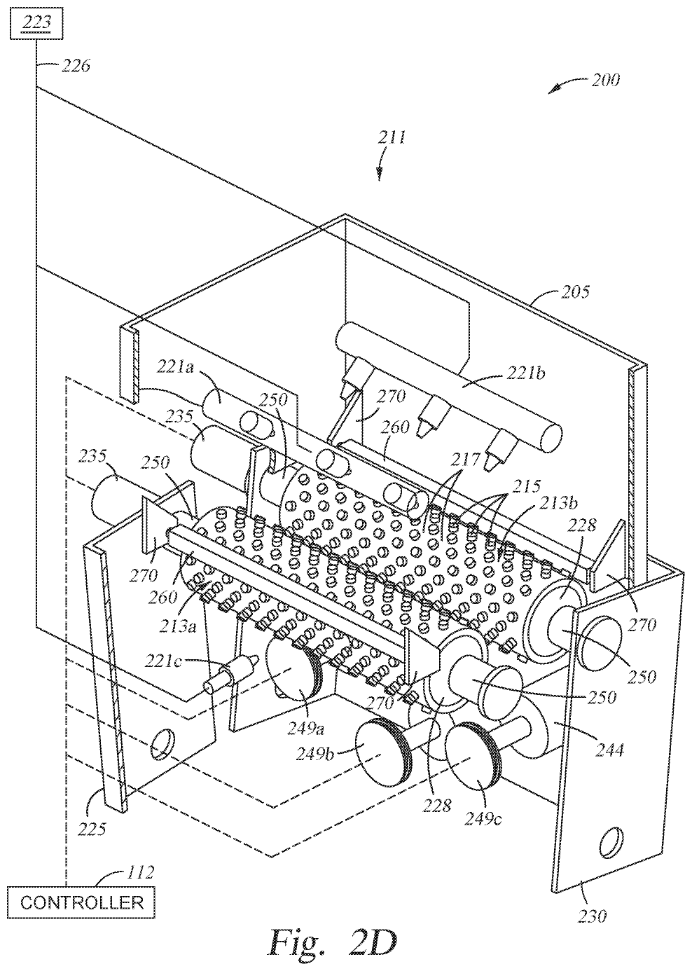

FIG. 2A is an isometric view of a brush cleaner 200 that may be utilized in the integrated hybrid bonding platform 100 as described above. The lid portion of the brush cleaner 200, which includes the door, has been removed from FIGS. 2A and 2B for ease of discussion. The brush cleaner 200 shown in FIG. 2A can be a scrubber type brush box-type vertical cleaner. The example brush cleaner 200 includes a tank 205 that is supported by a first support 225 and a second support 230. The brush cleaner 200 includes actuators 235, each actuator 235 coupled to a cylindrical roller 228 located inside the tank 205 (shown in FIG. 2B). The actuators 235 may each include a drive motor, such as direct drive servo motor, that is adapted to rotate the respective cylindrical rollers about axes A′ and A″ (shown in FIG. 2B). Each of the actuators 235 are coupled to the controller 112 adapted to control the rotational speed of the cylindrical rollers.

The linkage 210 and actuator 245 are configured to allow movement of the cylindrical rollers 228 located inside the tank 205 relative to the major surfaces of a substrate 201 (shown in FIG. 2B). The actuator 245 is coupled to the controller 112 to control the movement of the linkage 210 relative to a substrate disposed between the cylindrical rollers 228. In operation, the first and second supports 225, 230 may be moved simultaneously relative to the base 240. Such movement may cause the first and second cylindrical rollers 228 to close against the substrate 201 as shown in FIG. 2C, or to cause the first and second cylindrical rollers 228 to be spaced apart as shown in FIG. 2D to allow insertion and/or removal of the substrate 201 from the brush cleaner 200.

FIG. 2B is a top view of the brush cleaner 200 in FIG. 2A showing the cylindrical rollers 228 in a processing position where the cylindrical rollers 228 are closed or pressed against major surfaces of the substrate 201. The brush cleaner 200 also includes one or more drive motors 244 and a rotational device 247. Each of the drive motors 244 and the rotational device 247 include a roller 249, which is disposed at the end of an output shaft of each drive motor 244 and rotational device 247 and are configured to support and/or engage the substrate 201 and facilitate rotation of the substrate 201 about an axis that is parallel to the horizontal plane (i.e., X-Y plane).

Each of the cylindrical rollers 228 include a tubular cover (tubular covers 213a, 213b shown in FIGS. 2C and 2D; not shown in FIG. 2B) disposed thereon. The tubular covers 213a, 213b may be a removable sleeve made of a pad material utilized to polish the substrate 201 or a brush body adapted to clean the substrate 201. Tubular covers 213a, 213b are also referred to as scrubber brushes herein. During processing in the brush cleaner 200 the tubular covers 213a, 213b of the cylindrical rollers 228 are brought into contact with a substrate while they are rotated by the actuators 235, and while the substrate 201 is rotated by use of the supporting rollers 249 that are coupled to the output shafts of the drive motors 244 and rotational device 247. A second processing fluid, such as deionized (DI) water and/or one or more second substrate cleaning fluids (e.g., acid or base containing aqueous solution), is applied to the surface of the substrate 201 from a second fluid source while the substrate 201 and cylindrical rollers 228 are rotated by the various actuators and motors.

According to an embodiment, a dedicated conditioning device 260 may be provided for each of the cylindrical rollers 228. Conditioning device 260 may also be referred to as a “beater bar.” The conditioning device 260 is mounted adjacent a sidewall of the tank 205 by one or more support members 270. The conditioning device 260 is positioned away from the center of the tank 205 so as to not interfere with substrate transfer and/or substrate polishing or cleaning processes. However, the conditioning device 260 is positioned to contact each of the cylindrical rollers 228 when the first and second supports 225, 230 are actuated downward and outward away from one another. In one embodiment, the movement of the first and second supports 225, 230 brings the cylindrical rollers 228 into contact with a respective conditioning device 260. In this position, the processing surface of the tubular covers 213a, 213b on each of the cylindrical rollers 228 may be conditioned during relative movement between the cylindrical rollers 228 and the conditioning device 260. In one or more embodiments, the dedicated conditioning device 260 (“beater bar”) is used during the brush cleaning operation to enhance the brush cleaning.

FIG. 2C is an isometric view of one or more embodiments of a scrubbing device 211 disposed within the brush cleaner 200. The scrubbing device 211 shown in FIG. 2C is depicted with a substrate 201 loaded therein, such that the scrubbing device 211 is in a loaded state. The scrubbing device 211 comprises a pair of cylindrical rollers 228 including a pair of tubular covers 213a, 213b. In one or more embodiments, the pair of tubular covers 213a, 213b are polyvinyl acetate (PVA) brushes. Each brush includes a set of multiple raised nodules 215 across the surface of the brush, and a set of multiple valleys 217 located among the nodules 215. The pair of cylindrical rollers 228 are supported by a pivotal mounting adapted to move the pair of tubular covers 213a, 213b of the cylindrical rollers 228 into and out of contact with the substrate 201 (e.g., a semiconductor wafer) supported by a substrate support (which may also be referred to as a wafer support), thus allowing the cylindrical rollers 228 to move between closed and open positions so as to allow a substrate 201 to be extracted from and inserted therebetween as described below.

The scrubbing device 211 also comprises a substrate support adapted to support and further adapted to rotate a substrate 201. In one aspect, the substrate support may comprise a plurality of rollers 249 a-c (FIGS. 2C-2D) each having a groove adapted to support the substrate 201 vertically. A first motor (or motors) of actuators 235 are coupled to the cylindrical rollers 228 and adapted to rotate the tubular covers 213a, 213b of the cylindrical rollers 228 respectively in clockwise or counterclockwise rotation directions. Second motors 244 are coupled to the rollers 249a and 249c, respectively, and adapted to rotate the rollers 249a and 249c, while a third motor 247 is coupled to rollers 249b and is adapted to rotate the roller 249b.

The scrubbing device 211 may further comprise a plurality of sprayers 221 (including at least 221a, 221b, 221c and 221d) coupled to a source 223 of cleaning fluid via a supply pipe 226. The sprayers 221 are configured to dispense a high-pressure liquid spray onto the substrate surfaces, aiding in the removal of particles, contaminants, and residues. The sprayers 221 can incorporate various configurations, such as a fluid jet, spray bar with nozzles, shower-style spray manifold, or cryogenic aerosol jet.

In various embodiments of the present disclosure, the cleaning fluid utilized in the brush cleaner may include, but are not limited to deionized (DI) water, diluted citric acid, diluted Quaternary ammonium compound (a mixture of organic solvents, such as glycol ether, tetramethyl ammonium hydroxide, and other additives), diluted ammonium hydroxide (NH₄OH), diluted hydrogen peroxide (H₂O₂), NH₄OH and H₂O₂ mixture (SC1), diluted hydrofluoric acid, sulfuric acid (H₂SO₄) and hydrogen peroxide (H₂O₂) mixture (SPM), Electra clean, or any other liquid solution used for substrate cleaning.

In one or more embodiments, the sprayers 221 may be positioned to spray a cleaning fluid at the surfaces of the substrate 201 or at the one or more scrubber brushes (e.g., including tubular covers 213a, 213b) during a scrubbing process. In one or more embodiments, substrate cleaning fluid and/or brush cleaning fluid, discussed below, may be supplied from an internal region of the scrubber brushes (e.g., cylindrical rollers 228 and tubular covers 213a, 213b) themselves. Fluids provided to the interior of the scrubber brushes will pass through pores in the tubular covers 213 to clean the surface of the substrate or remove debris found on the surface of the scrubber brushes.

FIG. 2D is an isometric view of the one or more embodiments of the scrubbing device 211 of the brush cleaner 200, depicted when a substrate is not loaded, such that the scrubbing device 211 is in an idle state. In the idle state, the scrubbing device 211 may perform a brush cleaning operation. In one or more embodiments, when performing a brush cleaning operation, the scrubbing device 211 is not available to perform a substrate cleaning operation. The plurality of sprayers 221 is coupled to a source 223 of brush cleaning fluid via the supply pipe 226. The sprayers 221 may be positioned to spray the brush cleaning fluid at the one or more scrubber brushes (e.g., including tubular covers 213a, 213b). In one or more embodiments, brush cleaning fluid may be supplied through the scrubber brushes themselves.

In one or more embodiments, the brush cleaning fluid is the same as the substrate cleaning fluid. In one or more embodiments, the brush cleaning fluid is different from the substrate cleaning fluid. For example, the brush cleaning fluid is hydrofluoric acid (e.g., dilute hydrofluoric acid), SPM, or SC1 (e.g., hydrogen peroxide) and the substrate cleaning fluid is a different solution from hydrofluoric acid, SPM or SC1. In this case, it is desirable to use a brush cleaning fluid that is configured to efficiently clean and remove debris from the surfaces of the scrubber brushes to improve subsequent substrate cleaning steps. However, these brush cleaning chemistries may attack and damage one or more materials disposed on a surface of a substrate that is to be cleaned in the brush cleaner 200. Therefore, the brush cleaning processes need to be performed separately of the substrate cleaning processes.

In one or more embodiments, the sprayers 221 include a first set of sprayers 221a, 221b for the substrate cleaning fluid, and a second set of sprayers 221c, 221d for the brush cleaning fluid. In these embodiments, the supply pipe 226 is separated into separate supplies (not shown) for the source 223 of the substrate cleaning fluid and the brush cleaning fluid.

Overall, the brush cleaner 200 ensures efficient cleaning of substrates in a variety of applications. The modular design and the adjustable supports enable the brush box to accommodate substrates of different sizes and shapes. The actuators, cylindrical rollers, and conditioning devices work in unison to deliver an optimized cleaning process that minimizes the risk of substrate damage while maximizing the cleaning efficiency.

In operation, the substrate handling system carries the substrate 201 to the brush cleaner 200. This system employs precise handling techniques and controlled transport to ensure the substrate's position and orientation are accurate as it enters the module. The entire cleaning process is done in a housing that encloses the substrate, providing a controlled environment for the cleaning process. In this environment, the cleaning agent delivery system applies a uniform layer of cleaning agent onto the substrate's surface, ensuring effective cleaning across the entire surface.

As the cleaning agent covers the substrate, a set of brushes gently scrub the surface to chemically and mechanically remove residues and particles. The brushes work in tandem with the cleaning agent, optimizing cleaning performance while minimizing the risk of substrate damage. Simultaneously, rollers support the substrate and rotate it to guarantee that the brushes and cleaning agent clean all areas of the surface effectively. The controller 112 manages the various components, adjusting parameters like brush rotation speed, cleaning agent flow rate, and roller rotation speed for maximum efficiency.

Once the scrubbing is complete, the substrate is rinsed with deionized water or another appropriate rinsing agent. This step removes any remaining cleaning agent and dislodged particles from the surface. A drying mechanism, such as air knives or spin drying, is then employed to remove residual moisture from the substrate, ensuring a clean and dry surface for subsequent processes.

After the cleaning process is finished, the substrate handling system transports the cleaned substrate to the next process module. This transport maintains the cleanliness of the substrate and ensures proper alignment and orientation for the upcoming processes.

Throughout the entire operation, a controller 112 manages the various components within the brush cleaner. This controller 112 ensures accurate and efficient cleaning by adjusting parameters such as brush rotation speed, cleaning agent flow rate, and roller rotation speed. The controller 112 may also provide feedback on the cleaning performance, enabling operators to optimize the process for improved substrate cleanliness and process efficiency.

In addition to the features described above, an embodiment of the brush box can include optional components and accessories to improve its cleaning performance. For example, a temperature control system can be integrated into the brush box to regulate the temperature of the cleaning fluid, ensuring optimal cleaning conditions for specific substrates and cleaning agents. The brush box can also be configured to support multiple cleaning stages with different cleaning fluids, brushes, or other cleaning mechanisms, such as cryogenic aerosol, allowing for a more thorough and customized cleaning process tailored to specific substrate requirements. This flexibility makes the brush box suitable for a wide range of industries and applications, including semiconductor manufacturing, solar panel production, glass processing, and various other industries that require precise and efficient cleaning of substrates.

In one or more embodiments, the brush box module incorporates an integrated cryogenic aerosol system as a form of cleaning agent delivery system to enhance the effectiveness of substrate cleaning in a hybrid bonding process. In one embodiment, integrated cryogenic aerosol system may be a spray bar configured with multiple cryogenic aerosol jets. The cryogenic aerosol cleaning system consists of a cryogenic aerosol particle source and a nozzle designed to direct a high-velocity jet of cryogenic aerosol particles towards the substrate. Cryogenic aerosol particles are produced from a cryogenic fluid, such as liquid nitrogen, liquid carbon dioxide, or liquid argon, which is vaporized and rapidly expands to create a jet of particles. The aerosol jet can be adjusted to control the angle, direction, and velocity of the cryogenic aerosol particles, ensuring targeted and efficient cleaning.

The brush box module in this embodiment includes a cryogenic aerosol delivery system configured to generate and direct the cryogenic aerosol particles towards the substrate surface. The module may also comprise brushes, which can be used in conjunction with the cryogenic aerosol particles to enhance the cleaning process. The brushes can be designed to engage with the substrate surface, allowing for the mechanical removal of stubborn residues and particles. The cryogenic aerosol particles act as a cleaning agent by impinging upon the surface contaminants, causing them to freeze, embrittle, and subsequently break away from the substrate surface. This combined action of cryogenic aerosol particles and brushes results in a highly effective and damage-free cleaning process.

A controller 112 within the brush box module coordinates the operation of the brush assembly and the cryogenic aerosol cleaning system, optimizing cleaning efficiency and substrate compatibility. The cryogenic aerosol cleaning system can operate in a pulsed or continuous mode, depending on the specific cleaning requirements and substrate properties.

This brush box module with integrated cryogenic aerosol jet offers several advantages over conventional cleaning methods. The use of cryogenic aerosol particles eliminates the need for liquid chemicals, which can cause watermarks, scratches, corrosion, or surface roughness. Additionally, the cryogenic aerosol cleaning process provides versatile and effective cleaning solution for various types of contaminants and substrate materials, resulting in a cleaner and more passivated surface suitable for high-yield hybrid bonding applications.

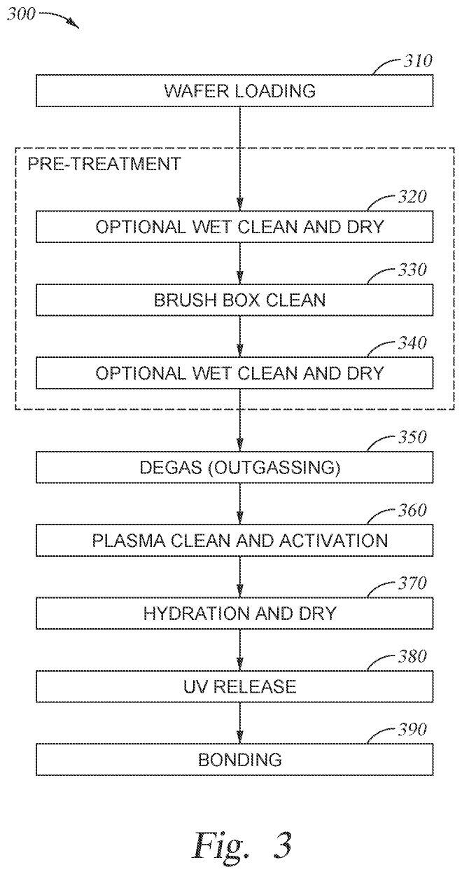

FIG. 3 is a flowchart illustrating an exemplary process 300 for manufacturing a stacked semiconductor structure according to an embodiment of the present disclosure. The process 300 begins at operation 310, where wafers 110 comprising a plurality of dies are initially loaded into the Equipment Front End Module 120 of the integrated hybrid bonding system. The system controller 112 is configured to perform a pre-programmed process sequence that guides the Automated Modular Mainframe 130 to transfer the wafers to different modules for processing.

At operation 320, an optional wet clean and dry process may be employed to remove contaminants from the wafer surface. Afterward, the brush box clean process (e.g., operation 330) takes place. The substrate undergoes a brush cleaning process within a brush box clean module (e.g., 140A or 140B), which uses a combination of brush rollers, cleaning solutions, and high-pressure sprayers to effectively remove particles and contaminants from the substrate surface.

Operation 340 represents another optional wet clean and dry process, similar to operation 320, which may be carried out to further enhance the cleanliness of the wafer surface. Once the cleaning steps are completed, the wafer is moved to the degas module, where it is subjected to a thermal process that evaporates moisture and other adsorbed contaminants from the wafer surface and reduces plastic outgassing from the tape frame (e.g., operation 350) during subsequent vacuum processing.

At operation 360, the wafer surface is activated using a plasma module, which employs ion bombardment to make the surface hydrophilic, thereby facilitating better bonding. Plasma activation ensures that the bonding process results in a high-quality stacked semiconductor structure.

Operation 370 involves hydration and drying of the substrate surface. This step ensures optimal bonding conditions by hydrating the surface and subsequently drying it to remove excess moisture.

In operation 380, the UV release process is executed. A UV module (e.g., 180) is used to expose the adhesive tape frame holding the dies to ultraviolet light, causing the adhesive's molecular structure to change. This results in a reduction of adhesive strength, allowing the dies to be easily released from the tape frame.

Finally, at operation 390, the bonder 190 ejects, picks up, flips, and bonds the dies to the substrate. The dies are bonded to the substrate wafer to form the desired stacked semiconductor structure. Throughout the entire process, an in-line metrology system may be used to inspect and verify the alignment and positioning of dies and substrates, ensuring high-quality stacked semiconductor structures.

This exemplary process of manufacturing a stacked semiconductor structure using the integrated hybrid bonding platform showcases the advantages of a streamlined, automated system that effectively combines various modules and technologies to achieve high-performance die-stack bonding. By incorporating the brush box cleaning module into the hybrid bonding platform, the present disclosure provides an effective and efficient method for removing residues and particles from die surfaces in die-stack bonding applications, leading to enhanced bonding yield. The brush box cleaning module is advantageous over traditional wet clean methods, as it can remove stubborn residues and particles that are strongly adhered to the surface of the substrate without causing watermarks, scratches, corrosion, or surface roughness.

In alternative embodiments, the hybrid bonding platform and brush box assembly may be adapted to accommodate different substrate sizes, shapes, and materials. For example, the brush box assembly may be configured to clean substrates made of silicon, glass, or quartz materials. Similarly, the brush box assembly may be adapted to clean substrates having various dimensions, such as 200 mm, 300 mm, or 450 mm wafers.

In some embodiments, the brush box cleaning module may include multiple brush box assemblies configured in parallel or in series to enhance the cleaning efficiency and effectiveness. For instance, the brush box cleaning module may include a first brush box assembly configured to remove coarse particles and residues, followed by a second brush box assembly configured to remove fine particles and residues.

In yet other embodiments, the brush box cleaning module may be configured to use different types of brushes or cleaning agents, depending on the specific cleaning requirements and substrate materials. For example, the brushes may be made of various materials, such as polyvinyl alcohol/acetate (PVA), nylon, polypropylene, or other suitable materials, with different porous structures or bristle containing structures that have a desired stiffness and structural configuration. The cleaning agents may include deionized (DI) water, diluted citric acid, diluted Quaternary ammonium compound (a mixture of organic solvents, such as glycol ether, tetramethyl ammonium hydroxide, and other additives), diluted ammonium hydroxide (NH₄OH), diluted hydrogen peroxide (H₂O₂), NH₄OH and H₂O₂ mixture (SC1), diluted hydrofluoric acid, sulfuric acid (H₂SO₄) and hydrogen peroxide (H₂O₂) mixture (SPM), Electra clean, or other suitable chemicals for effectively removing residues and particles.

In addition to die-stack bonding applications, the hybrid bonding platform and brush box assembly may be employed in other semiconductor manufacturing processes that require clean substrate surfaces, such as wafer bonding, 3D integration, or advanced packaging processes.

It should be noted that the present disclosure is not limited to the specific embodiments and applications described herein, and that modifications, variations, and alternative embodiments may be made without departing from the spirit and scope of the disclosure as defined by the appended claims.

What is claimed is:

1. A hybrid bonding platform comprising:
a substrate handling system configured to transport a substrate through the platform;
a brush box cleaning module coupled to the platform and configured to clean a surface of the substrate by removing residues and particles;
a bonding module coupled to the platform and configured to bond dies to the surface of the substrate; and
a controller configured to control the substrate handling system, the brush box cleaning module, and the bonding module.

2. The hybrid bonding platform of claim 1, wherein the substrate handling system is further configured to transport the substrate between different process modules.

3. The hybrid bonding platform of claim 1, wherein the brush box cleaning module is configured to remove residues and particles induced by backgrinding tape or dicing tape.

4. The hybrid bonding platform of claim 1, wherein the brush box cleaning module comprises a plurality of brushes configured to chemically and mechanically remove stubborn residues and particles from the substrate surface.

5. The hybrid bonding platform of claim 1, wherein the bonding module is configured to perform a hybrid bonding process on the cleaned surface of the substrate.

6. The hybrid bonding platform of claim 1, further comprising a system controller for managing and controlling the operation of each process module.

7. A brush box assembly for cleaning a substrate in a hybrid bonding platform, the brush box assembly comprising:
a housing configured to enclose the substrate;
a plurality of brushes configured to gently scrub a wafer surface;
a plurality of rollers configured to support and rotate the wafer during the cleaning process;
a cleaning agent delivery system configured to apply a cleaning agent to the wafer surface during the scrubbing process.

8. The brush box assembly of claim 6, further comprising a controller configured to control the operation of the brushes, rollers, and cleaning agent delivery system.

9. The brush box assembly of claim 6, wherein the plurality of brushes are configured to chemically and mechanically remove stubborn residues and particles induced by backgrinding tape or dicing tape from the substrate surface.

10. The brush box assembly of claim 6, wherein the cleaning agent delivery system is configured to deliver the cleaning agent to the plurality of brushes to facilitate removal of residues and particles from the substrate surface.

11. The brush box assembly of claim 6, wherein the cleaning agent delivery system comprises a cryogenic aerosol jet configured to dispense a cryogenic cleaning agent onto the substrate surface during the scrubbing process.

12. A process of manufacturing a stacked semiconductor structure, the process comprising:
providing a substrate comprising a plurality of dies;
cleaning a surface of the substrate using a brush box cleaning module to remove residues and particles; and
bonding the dies of the substrate using a hybrid bonding process.

13. The process of claim 11, wherein cleaning the surface of the substrate comprises removing residues and particles induced by backgrinding tape or dicing tape.

14. The process of claim 11, wherein cleaning the surface of the substrate comprises chemically and mechanically removing stubborn residues and particles using a plurality of brushes.

15. The process of claim 11, wherein the cleaning step with at least one wet clean module is optional and can be performed before and/or after the brush box cleaning module step.

16. The process of claim 11, wherein the at least one degas module heats the wafer surface to evaporate water moisture and reduce plastic outgassing from the tape frame.

17. The process of claim 11, wherein the at least one plasma module uses ion bombardment to activate the wafer surface, making it hydrophilic for bonding.

18. The process of claim 11, wherein the at least one bonder module accurately aligns and bonds dies to substrates, creating a stacked semiconductor structure.

19. The process of claim 11, wherein the stacked semiconductor structure has enhanced bonding yield due to the removal of residues and particles by the brush box cleaning module.
